(19) United States
(12) Patent Application Publication
(10) Pub. No.: US 2003/0202857 A1
(43) Pub. Date: Oct. 30, 2003

(54) Screw-nail member, anchoring device, and articles using same

(76) Inventors: Joseph William Lowry, Liberty, IL (US); Eustathios Vassiliou, Newark, DE (US)

Correspondence Address: Eustathios Vassiliou, Ph. D, Patent Agent, TERMAX CORPORATION, 920 Remington Avenue, Schaumburg, IL, 60173, US

(21) Appl. No.: 10/209,775

(22) Filed: Aug. 1, 2002

Related U.S. Application Data
(60) Provisional application No. 60/376,828, filed on Apr. 29, 2002.
(60) Provisional application No. 60/380,539, filed on May 14, 2002.

(51) Int. Cl. F16B 37/04

(52) U.S. Cl. 411/182

(57) ABSTRACT

This invention is related to a screw-nail member, to anchoring devices, articles using the anchoring devices to be secured on each other, and vehicles comprising one or more of the above. The screw-nail member has a first head, a screw upper portion toward the first head, and a leading nail lower portion away from the head. The screw-nail member may be used with conjunction with a spring fastener having a second head and two legs. The leading nail lower portion expands the legs of the fastener for securing a first object on a second object before the upper screw portion engages on the upper side of the second head of the fastener. This eliminates bowing of the head, which occurs when conventional screws or bolts are used with the fastener. In addition, engagement requires only push-in action with minimal turning of the screw-nail member, thus considerably improving productivity.

### RELATED APPLICATIONS

This application claims priority of provisional patent application 60/380,539, filed on May 14, 2002, which is incorporated herein by reference in its entirety.

### FIELD OF THE INVENTION

This invention pertains fasteners and anchoring devices, as well as articles using said fasteners and anchoring devices with particular emphasis to utilization of such species in facilitating easy and efficient assembly.

### BACKGROUND OF THE INVENTION

In the original conventional technology of fasteners employed to securely attach one object to another, such as for example one part to another in the case of an automobile, an appliance, or any other device, there has been utilized a nut on one of the two objects, usually welded or glued to the back of said object, and a bolt passing through a hole on the second object in a manner to be engaged by the nut, thereby securing the two objects together.

This arrangement presents many problems, among which, one of the most important is that in the case that one object is hollow, the nut has to be in place at the back of the hollow object before assembling the two objects together. If for any reason the nut is misplaced, and/or if it becomes desirable to introduce a new fastening connection between the two objects, the task of achieving such connection becomes very difficult if not impossible for all practical purposes.

The so-called “quick nuts” have also been used to connect two objects. In addition, vibration during the operation of a device, such as an automobile or appliance for example, containing the two objects results very often in loosening of the bolt or “quick nut” and in either full disassembling of the objects from each other, or in a vibration noise which is most annoying and often of unacceptable levels. Further, such connections are not water-resistant and water may be easily penetrate the connection point and be transferred from one side of one or both objects to the other side.

Later, fasteners of the type described in U.S. Pat. No. 4,500,238 (Vassiliou), which patent is incorporated herein by reference, have been utilized to reduce considerably the potential of bolt or screw loosening and vibration. Examples of improved fasteners and anchoring devices belonging to the same family are also described in U.S. Pat. Nos. 4,765,788 (Nowak et al.), 4,874,277 (Nowak et al.), 4,941,340 (Nowak et al.), 5,100,273 (Vassiliou) 5,725,343 (Smith), 6,250,864 B1 (Vassiliou), 6,280,129 B1 (Lowry et al.), 6,299,399 B1 (Smith et al.), and 6,379,092 (Patel et al.), all of which are incorporated herein by reference.

All these anchoring devices with the exception of U.S. Pat. No. 5,100,273 (Vassiliou) have at least two major drawbacks. First, there is considerable time consumed (especially as far as an assembly line is concerned) for the complete engagement of an expanding member, such as a screw for example, onto the fastener for holding a first object onto a second object. Second, during the insertion and engagement of the expanding member, the upper side of the head of the fastener bows to a certain degree, which is objectionable in many applications. In these cases, the fastener is inserted into a slot of the first object, and the second object is held by the expanding member, which also expands the legs of the fastener, thus securing the fastener onto the first object.

In the case of U.S. Pat. No. 5,100,273 the drawbacks encountered in the other cases do not exist, but a different drawback is created. The two objects to be fastened to each other, have to be held by the fastener itself, and the major role of the screw is to expand the legs of the fastener. This is objectionable in many applications.

The present invention eliminates all the aforementioned drawbacks.

### SUMMARY OF THE INVENTION

As aforementioned, this invention pertains fasteners and anchoring devices, as well as articles using said fasteners and anchoring devices with particular emphasis to utilization of such species in facilitating easy and efficient assembly.

More particularly, this invention pertains a screw-nail member comprising a first head and a main body, the main body comprising a screw upper portion and a leading nail lower portion extending away from the upper portion and lacking threads, the upper portion being closer to the head than the lower portion and having a substantially constant outside first diameter, the upper portion and the lower portion being integral parts of each other, the lower portion having a maximum cross-sectional diameter smaller than the first diameter.

The screw upper portion may be in the vicinity of the first head, or the screw-nail member may comprise an unthreaded portion between the screw upper portion and the first head.

The lower portion may have a cross-section selected from a group consisting essentially of substantially round, substantially oval, rectangular, square, polygonal, reverse bell, and a combination thereof.

The present invention is also related to and anchoring device comprising:

a screw-nail member comprising a first head and a main body, the main body comprising a screw upper portion and a leading nail lower portion extending away from the upper portion and lacking threads, the upper portion being closer to the head than the lower portion and having a substantially constant outside first diameter, the upper portion and the lower portion being integral parts of each other; and

a fastener comprising

a second head having a hole engageable to the upper portion of the screw-nail member;

a neck extending from the head in a substantially perpendicular direction; and

two legs in initial close proximity to each other, the two legs extending from the neck, and having contact regions, the legs expanding when the screw-nail member is inserted through the hole and presses upon the contact regions, wherein the leading nail lower portion has a maximum diameter adequately small to be passed through the engageable hole.

In addition, the instant invention pertains a combination comprising:

an anchoring device, the anchoring device comprising:

a screw-nail member comprising a first head and a main body, the main body comprising a screw upper portion and a leading nail lower portion extending away from the upper portion and lacking threads, the upper portion being closer to the head than the lower portion and having a substantially constant outside first diameter, the upper portion and the lower portion being integral parts of each other; and

a fastener comprising

a second head having a hole engageable to the upper portion of the screw-nail member;

a neck extending from the head in a substantially perpendicular direction; and

two legs in initial close proximity to each other, the two legs extending from the neck, and having contact regions, the legs expanding when the screw-nail member is inserted through the hole and presses upon the contact regions, wherein the leading nail lower portion has a maximum diameter adequately small to be passed through the engageable hole.

a first object having a first opening commensurate to the fastener; and

a second object having a second opening commensurate to the screw-nail member;

wherein, when the combination is assembled, the fastener is fully inserted into the first opening, the legs of the fastener are opened by at least the lower portion of the screw-nail member, the screw-nail member is inserted into the second opening and engaged on the hole of the second head by the screw upper portion.

It is preferable that the legs of the fastener are held open by the lower portion of the screw-nail member.

Further, this invention is related to a vehicle comprising a first object and a second object connected with an anchoring device comprising a screw-nail member, which screw-nail member comprises a first head and a main body, the main body comprising a screw upper portion and a leading nail lower portion extending away from the upper portion and lacking threads, the upper portion being closer to the head than the lower portion and having a substantially constant outside first diameter, the upper portion and the lower portion being integral parts of each other, the lower portion having a maximum diameter smaller than the first diameter.

The anchoring device of the vehicle may further comprise a fastener comprising:

a second head having a hole engageable to the upper portion of the screw-nail member;

a neck extending from the head in a substantially perpendicular direction; and

two legs in initial close proximity to each other, the two legs extending from the neck, and having contact regions, the legs expanding when the screw-nail member is inserted through the hole and presses upon the contact regions, wherein the leading nail lower portion has a maximum diameter adequately small to be passed through the engageable hole.

Preferably, the first object has a first opening commensurate to the fastener, the second object has a second opening commensurate to the screw-nail member, and the fastener is fully inserted into the first opening, the legs of the fastener are held open by the screw-nail member, the screw-nail member is inserted into the second opening and engaged on the hole of the head of the fastener by the upper threaded portion.

In all cases of anchoring devices, combinations, vehicles, etc., the screw-nail member may have any appropriate configuration, including the configurations described above.

Outside diameter of a screw portion is the diameter of a hole through which the screw portion can just pass through.

Maximum diameter of a cross section is defined as the distance between the two most remote points of the cross section.

Reverse bell configuration is a configuration wherein the cross section changes in a manner that the cross section closer to the first head is larger than the cross section away from the first head, as it will be exemplified in more detail at a later point.

The upper side of the second head and the lower side of the second head of the fastener of the instant invention may be substantially in contact or separated by a gap, depending on the application.

The engageable hole of the fastener may have a substantially round shape or it may be oblong as described for example in U.S. Pat. No. 6,280,129 B1 (Lowry et al.).

When water-proofing, and/or gas-proofing are desired for a particular application, and/or vibration noises are to be prevented, an elastic body is preferably integrally molded at least at the lower side of the substantially flat head portion. Such elastic bodies are for example disclosed in U.S. Pat. Nos. 5,725,343 (Smith) and 6,379,092 B1 (Patel et al.).

### BRIEF DESCRIPTION OF THE DRAWING

The reader's understanding of this invention will be enhanced by reference to the following detailed description taken in combination with the drawing figures, wherein:

FIG. 1 is a perspective view illustrating a screw-nail member according to a preferred embodiment of the present invention.

FIG. 2 is a perspective view illustrating a screw-nail member according to another preferred embodiment of the present invention.

FIG. 3 is a perspective view illustrating a screw-nail member according to still another preferred embodiment of the present invention.

FIG. 4A is a cross-sectional view illustrating an example of a cross-section that the leading nail lower portion of the screw-nail member may have according to a preferred embodiment of the present invention.

FIG. 4B is a cross-sectional view illustrating another example of a cross-section that the leading nail lower portion of the screw-nail member may have according to another preferred embodiment of the present invention.

FIG. 4C is a cross-sectional view illustrating another example of a cross-section that the leading nail lower portion of the screw-nail member may have according to another preferred embodiment of the present invention.

FIG. 4D is a cross-sectional view illustrating another example of a cross-section that the leading nail lower portion of the screw-nail member may have according to another preferred embodiment of the present invention.

FIG. 4E is a cross-sectional view illustrating still another example of a cross-section that the leading nail lower portion of the screw-nail member may have according to another preferred embodiment of the present invention.

FIG. 5 is a perspective view illustrating a fastener, which may be used with the screw-nail member to form an anchoring device according to another preferred embodiment of the present invention.

FIG. 6 represents a combination of two objects connected with the anchoring device of the present invention.

FIG. 7 represents a conventional anchoring device wherein a conventional screw is used along with the fastener of FIG. 5, in which case, the upper side of the head of the fastener is caused to bow, and the time needed to connect objects together is considerably longer as compared to the time needed if the screw-nail of the present invention had been used in place of the conventional screw.

### DETAILED DESCRIPTION OF THE INVENTION

This invention pertains expanding fasteners which can secure two or more objects together, and are characterized by high prevailing torque and/or high pulling force. An example is two automobile parts, such as a plastic panel and a metal sheet, for example, secured together. The invention also pertains vehicles comprising parts connected with the novel fasteners described herein.

Referring now to FIG. 1, there is depicted a screw-nail member 10, which comprises a first head 12 and a main body 14. The main body 14 comprises a screw upper portion 16 and a leading nail lower portion 18 extending away from the upper portion 16. The leading nail lower portion 18 lacks threads. The upper portion 16 is closer to the head 12 than the lower portion 18 and has a substantially constant outside first diameter D1. The upper portion 16 and the lower portion 18 are integral parts of each other. The lower portion 18 has a maximum cross-sectional diameter D2 smaller than the outside first diameter D1.

Outside diameter of a screw is the diameter of a cylinder or hole through which the threaded part of the screw can just pass.

As aforementioned, maximum diameter of a cross section is defined, according to this invention, the distance between the two most remote points of the cross section. Examples of maximum diameters are shown in FIGS. 4A-4B of miscellaneous cross-sections, including circular, square, rectangular, combination, and oval, respectively.

According to this invention, the lower portion 18 may have any type of cross-sectional configuration, but the substantially circular (as shown in FIG. 4A) is the most preferred.

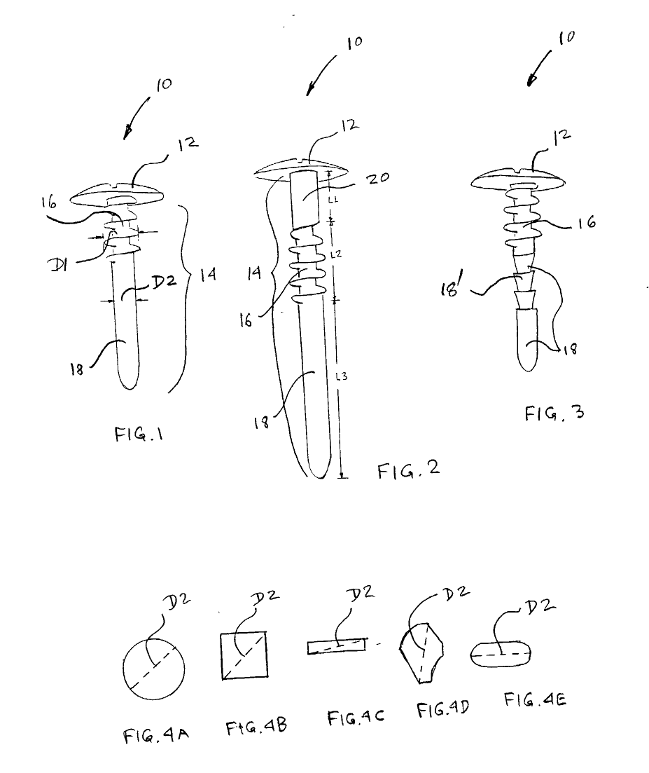

As shown in FIGS. 1 and 2, the screw upper portion 16 may be in the vicinity of the first head 12, or the screw-nail member 14 may comprise an upper unthreaded portion 20, having a length L1, between the screw upper portion 16 and the first head 12. The screw upper portion has a length L2. and the leading nail portion 18 has a length L3 The lower leading nail portion 18 may comprise reverse bell-shaped sections 18′, as better illustrated in FIG. 3. Reverse bell cross-section is defined as a cross-section that increases in size moving from the lower leading nail portion 18 toward the screw upper portion 16 up to a certain point as illustrated for example in FIG. 3. The reverse bell portions may serve as anchoring configurations.

The lengths of the unthreaded portion 20, the screw upper portion 16, and the leading nail lower portion 18 are such as to fit the appropriate application, as it will be explained hereinbelow.

Thus, the present invention is also related to and anchoring device comprising a screw-nail member as described above, and a fastener as illustrated for example in FIG. 5. Different versions of such fasteners are described in great detail in the aforementioned patents, which patents have been incorporated herein by reference. Such a fastener comprises a second head 24, which second hand 24 has a hole 26, on the upper side 23 of said head, engageable to the upper screw portion 16 of the screw-nail member 14.

The fastener 22 has also a neck 28 extending from the head 24 in a substantially perpendicular direction.

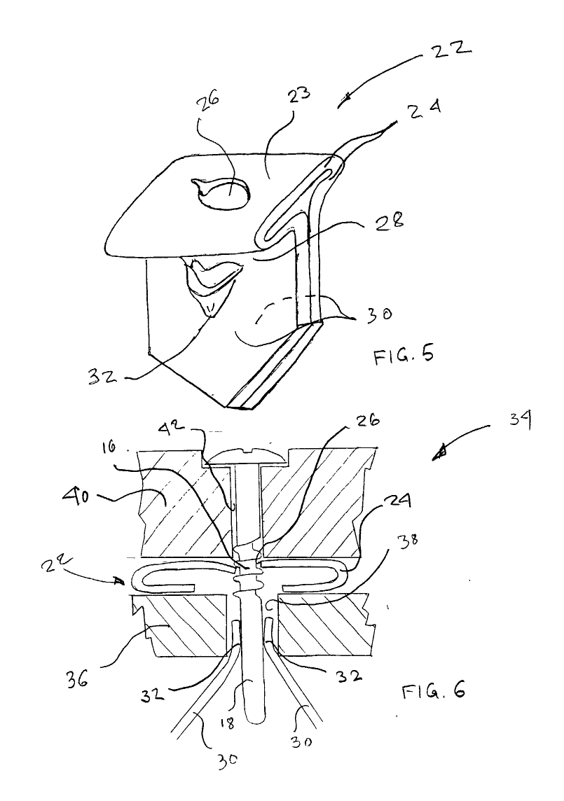

The fastener 22 further has two legs 30, which are in initial close proximity to each other. The two legs 30 extend from the neck 28, and have contact regions 32 (see FIGS. 5 and 6 for example). The legs expand when the screw-nail member 14 is inserted through the hole 26 and presses upon the contact regions 32.

It is necessary that the leading nail lower portion 18 has a maximum diameter adequately small to be passed through the engageable hole 26.

In addition, the instant invention pertains a combination 34 as better shown in FIG. 6, comprising an anchoring device as described above, a first object 36 having a first opening 38 commensurate to the fastener and a second object 40 having a second opening 42 commensurate to the screw-nail member.

It is important that when the combination 34 is assembled, the fastener 22 is fully inserted into the first opening 38, the legs 30 of the fastener are opened by at least the leading nail lower portion 18 of the screw-nail member 12, the screw-nail member 12 is inserted into the second opening 42 and engaged on the hole 26 of the second head 24 by the screw upper portion 16.

It is highly preferable that the legs 30 of the fastener are held open by the leading lower portion 18 of the screw-nail member 10, although they may also be held open by the screw upper portion 16, as long as the leading nail lower portion has expanded the legs first, as described hereinbelow.

In operation, the fastener 22 is fully inserted into the opening 38 of the first object 36, which may be a steel sheet for example. The opening 38 is preferably a slot. In sequence, the second object 40 is placed on top of the first object 36, so that the second opening 42 of the second object 40 aligns with the engageable hole 26. The second object 40 may be a plastic panel for example. The second opening 42 is preferably a substantially round hole. The screw-nail member 10 is then inserted initially to the second opening 42. The leading nail lower portion 18 first passes freely through the second opening 42, through the hole 26, and than it expands the legs 30 by pushing the contact regions 32 away from each other. It is highly preferable that the screw upper portion 16 reaches the engageable hole 26 after the legs 30 have been expanded. Up to this point, the screw-nail member may be inserted by simple pushing or by simultaneous turning and pushing. When the screw upper portion 16 reaches the engageable hole 26, even partial turning is adequate to engage the screw-nail member onto the fastener 22. Of course, it is preferable that more than one turns are used for securing the screw-nail member 10 on the fastener 22 in order to ensure safe engagement. It is important to mention, however, that only a few turns are more than adequate for this purpose.

Depending on the thickness of the second object 40 and the fastener 22, a person of ordinary skill in the art may select the lengths L1, L2 and L3, without undue effort or experimentation. The unthreaded portion 20 is not necessary for the purposes of this invention, but in some applications it may be desirable.

It is important to note that the initial expanding of the legs 30 requires considerably higher force than maintaining the legs 30 expanded as a screw or a nail is passing between the contact regions 32. This is a great advantage to the configuration of the screw-nail member of the instant invention. When the leading nail lower portion 18 is initially passing between the contact regions 32 expanding the legs 30, there is no force applied on the upper side 23 of the second head 24, since the screw upper portion 16 has not engaged yet on the engageable hole 26. Thus, the upper side 23 of second head 24 remains flat even after the engagement of the screw upper portion 16 on the hole 26, since the force applied on the upper side 23 of the head 24 after the opening of the legs 30 is minimal.

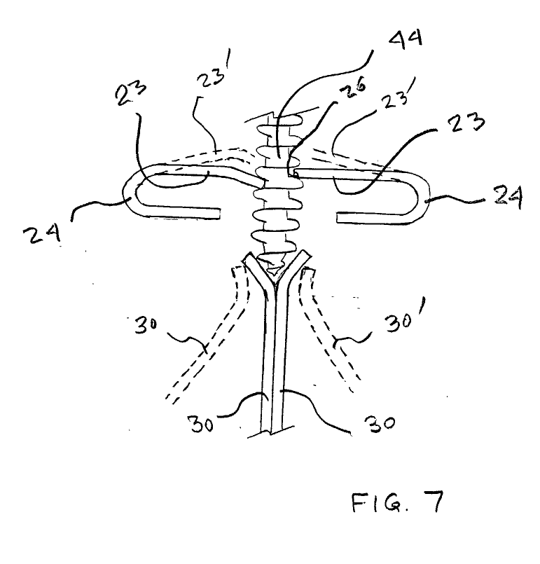

In contrast, in the case of using a conventional screw or bolt 44, as better illustrated in FIG. 7, when the opening of the legs 30 occurs for the legs to attain position 30′, the screw or bolt 44 is already engaged on the hole 26 applying a considerable force on the upper side 23 of the second head 24, thus bowing and attaining position 23′, which is unacceptable in many applications.

Another important advantage that this invention provides is the fact that the operator has to just push the nail-screw and with a couple of turns only secure the first object on the second object, which provides a very beneficial economical impact in all cases, and particularly considerably enhanced productivity in an assembly line.

Further, this invention is related to a vehicle comprising a first object and a second object connected with an anchoring device and or combinations as described above.

In all cases of anchoring devices, combinations, vehicles, etc., the screw-nail member may have any appropriate configuration, including the configurations described above.

Outside diameter of a screw portion is the diameter of a hole through which the screw portion can just pass through.

Maximum diameter of a cross section is defined as the distance between the two most remote points of the cross section.

Reverse bell configuration is a configuration wherein the cross section changes in a manner that the cross section closer to the first head is larger than the cross section away from the first head, as it will be exemplified in more detail at a later point.

The upper side of the second head and the lower side of the second head of the fastener of the instant invention may be substantially in contact or separated by a gap, depending on the application.

The engageable hole of the fastener may have a substantially round shape or it may be oblong as described for example in U.S. Pat. 6,280,129 B1 (Lowry et al.).

When water-proofing, and/or gas-proofing are desired for a particular application, and/or vibration noises are to be prevented, an elastic body is preferably integrally molded at least at the lower side of the substantially flat head portion. Such elastic bodies are for example disclosed in U.S. Pat. Nos. 5,725,343 (Smith) and 6,379,092 B1 (Patel et al.).

One or more of the above embodiments may be exercised simultaneously.

When water-proofing, and/or gas-proofing are desired for a particular application, and/or vibration noises are to be prevented, an elastic body is preferably integrally molded at least at the lower side of the substantially flat head portion. Such elastic bodies are for example disclosed in U.S. Pat. No. 5,725,343.

The embodiments described hereinabove serve for illustration purposes only regarding this invention, which should only be bound by the claims.

Any explanations given are speculative and should not restrict the scope of the claims.

What is claimed is:

1. A screw-nail member comprising a first head and a main body, the main body comprising a screw upper portion and a leading nail lower portion extending away from the upper portion and lacking threads, the upper portion being closer to the head than the lower portion and having a substantially constant outside first diameter, the upper portion and the lower portion being integral parts of each other, the lower portion having a maximum diameter smaller than the first diameter.

2. A screw-nail member as defined in claim 1, wherein the screw upper portion is in the vicinity of the first head.

3. A screw-nail member as defined in claim 1, further comprising an unthreaded portion between the screw upper portion and the first head.

4. A screw-nail member as defined in claim 1, wherein the lower portion has a cross-section selected from a group consisting essentially of substantially round, substantially oval, rectangular, square, polygonal, reverse bell, and a combination thereof.

5. A screw-nail member as defined in claim 4, wherein the screw upper portion is in the vicinity of the first head.

6. A screw-nail member as defined in claim 4, further comprising an unthreaded portion between the screw upper portion and the first head.

7. An anchoring device comprising:
a screw-nail member comprising a first head and a main body, the main body comprising a screw upper portion and a leading nail lower portion extending away from the upper portion and lacking threads, the upper portion being closer to the head than the lower portion and having a substantially constant outside first diameter, the upper portion and the lower portion being integral parts of each other; and
a fastener comprising
a second head having a hole engageable to the upper portion of the screw-nail member;
a neck extending from the head in a substantially perpendicular direction; and
two legs in initial close proximity to each other, the two legs extending from the neck, and having contact regions, the legs expanding when the screw-nail member is inserted through the hole and presses upon the contact regions,
wherein the leading nail lower portion has a maximum diameter adequately small to be passed through, the engageable hole.

8. An anchoring device as defined in claim 7, wherein the leading nail lower portion has a cross-section selected from a group 18 consisting essentially of round, oval, rectangular, square, polygonal, reverse bell, and a combination thereof.

9. An anchoring device as defined in claim 8, wherein the leading nail lower portion has a substantially round cross section.

10. An anchoring device as defined in claim 7, wherein the screw upper portion is in the vicinity of the first head.

11. An anchoring device as defined in claim 7, wherein the screw-nail member further comprises an unthreaded portion between the screw upper portion and the first head.

12. A combination comprising:
an anchoring device, the anchoring device comprising:
a screw-nail member comprising a first head and a main body, the main body comprising a screw upper portion and a leading nail lower portion extending away from the upper portion and lacking threads, the upper portion being closer to the head than the lower portion and having a substantially constant outside first diameter, the upper portion and the lower portion being integral parts of each other; and
a fastener comprising
a second head having a hole engageable to the upper portion of the screw-nail member;
a neck extending from the head in a substantially perpendicular direction; and
two legs in initial close proximity to each other, the two legs extending from the neck, and having contact regions, the legs expanding when the screw-nail member is inserted through the hole and presses upon the contact regions, wherein the leading nail lower portion has a maximum diameter adequately small to be passed through the engageable hole;
a first object having a first opening commensurate to the fastener; and
a second object having a second opening commensurate to the screw-nail member;
wherein, when the combination is assembled, the fastener is fully inserted into the first opening, the legs of the fastener are opened by at least the lower portion of the screw-nail member, the screw-nail member is inserted into the second opening and engaged on the hole of the second head by the screw upper portion.

13. A combination as defined in claim 12, wherein the leading nail lower portion has a cross-section selected from a group consisting essentially of round, oval, rectangular, square, polygonal, reverse bell, and a combination thereof.

14. A combination as defined in claim 13, wherein the leading nail lower portion has a substantially round cross section.

15. A combination as defined in claim 12, wherein the legs of the fastener are held open by the lower portion of the screw-nail member.

16. A vehicle comprising a first object and a second object connected with an anchoring device comprising a screw-nail member comprising a first head and a main body, the main body comprising a screw upper portion and a leading nail lower portion extending away from the upper portion and lacking threads, the upper portion being closer to the head than the lower portion and having a substantially constant outside first diameter, the upper portion and the lower portion being integral parts of each other, the lower portion having a maximum diameter smaller than the first diameter.

17. A vehicle as defined in claim 16, wherein the leading nail lower portion has a cross-section selected from a group consisting essentially of round, oval, rectangular, square, polygonal, reverse bell, and a combination thereof.

18. A vehicle as defined in claim 16, wherein the leading nail lower portion has a substantially round cross section.

19. A vehicle as defined in claim 16, wherein the anchoring device further comprises a fastener comprising:
a second head having a hole engageable to the upper portion of the screw-nail member;
a neck extending from the head in a substantially perpendicular direction; and
two legs in initial close proximity to each other, the two legs extending from the neck, and having contact regions, the legs expanding when the screw-nail member is inserted through the hole and presses upon the contact regions, wherein the leading nail lower portion has a maximum diameter adequately small to be passed through the engageable hole.

20. A vehicle as defined in claim 16, wherein the leading nail lower portion has a cross-section selected from a group consisting essentially of round, oval, rectangular, square, polygonal, reverse bell, and a combination thereof.

21. A vehicle as defined in claim 16, wherein the leading nail lower portion has a substantially round cross section.

22. A vehicle as defined in claim 16, wherein the first object has a first opening commensurate to the fastener, the second object has a second opening commensurate to the screw-nail member, and the fastener is fully inserted into the first opening, the legs of the fastener are held open by the screw-nail member, the screw-nail member is inserted into the second opening and engaged on the hole of the head of the fastener by the upper threaded portion.

23. A vehicle as defined in claim 22, wherein the leading nail lower portion has a cross-section selected from a group consisting essentially of round, oval, rectangular, square, polygonal, reverse bell, and a combination thereof.

24. A vehicle as defined in claim 23, wherein the leading nail lower portion has a substantially round cross section.

25. A vehicle as defined in claim 22, wherein the legs of the fastener are held open by the lower portion of the screw-nail member.
